(19) United States
(12) Patent Application Publication
(10) Pub. No.: US 2012/0070296 A1
(43) Pub. Date: Mar. 22, 2012

(54) ROTOR BLADE OR ROTOR BLADE SEGMENT FOR A WIND TURBINE

(76) Inventors: Hendrik Klein, Rostock (DE); Christian Günther, Hamburg (DE)

(21) Appl. No.: 13/231,154

(22) Filed: Sep. 13, 2011

(30) Foreign Application Priority Data
Sep. 22, 2010 (DE) 10 2010 046 519.4

(51) Int. Cl. F03D 11/00; B23P 15/04

(52) U.S. Cl. 416/204 R; 29/889.71

(57) ABSTRACT

A rotor blade or rotor blade segment for a wind turbine has at least one cable for the fixation of the rotor blade or rotor blade segment on a rotor hub or on the further rotor blade segment. A connecting surface, in the mounted state, faces the rotor hub or further rotor blade segment and from this connecting surface, a free end of the at least one cable protrudes for fixation on the rotor hub or further rotor blade segment. The at least one cable is anchored inside a connecting region of the rotor blade or rotor blade segment and extends only over a longitudinal section of the rotor blade or rotor blade segment which adjoins the connecting surface.

### CROSS REFERENCE TO RELATED APPLICATION

This application claims priority of German patent application no. 10 2010 046 519.4, filed Sep. 22, 2010, the entire content of which is incorporated herein by reference.

### FIELD OF THE INVENTION

The invention relates to a rotor blade or a rotor blade segment for a wind turbine which is fixed on a rotor hub or on a further rotor blade segment with a cable.

### BACKGROUND OF THE INVENTION

Conventionally, the connection of a rotor blade with a rotor hub is done by threaded fastener engagement of the rotor blade with a flange of the rotor hub. For this, the rotor blade can either also have a flange through which threaded bolts are passed, or the threaded bolts can be anchored in a wall of the rotor blade, for example, by threadably engaging in a metal cylinder having a threaded hole which is received in a bore in the wall of the rotor blade which runs perpendicularly to the longitudinal direction of the threaded connector.

Also known are rotor blades subdivided into multiple rotor blade segments. A connection between the rotor blade segments can also be achieved with threaded bolts. United States patent application publication 2010/0158694 discloses specially formed inserts which are fixedly connected to the rotor blade segments and receive the threaded bolts.

From U.S. Pat. No. 7,393,184, a different modular rotor blade constructed for wind energy turbines is known. The known rotor blade is constructed “section by section” from a plurality of rotor blade segments, whereby steel cables are guided through the entire length of the individual rotor blade segments and are fixed behind an end segment at the hub end and an end segment at the rotor blade tip end. In each rotor blade segment, special reinforcing elements, which are arranged in the interior of the rotor blade, run parallel to the steel cables.

### SUMMARY OF THE INVENTION

On the basis of the above, it is an object of the invention to provide a rotor blade or a rotor blade segment for a wind turbine generator which is particularly simply constructed and can be simply and stably fixed to a rotor hub or another rotor blade segment with at least one cable. It is also an object of the invention to provide a method for fixing such a rotor blade or rotor blade segment on a rotor hub or on a further rotor blade segment.

The rotor blade or rotor blade segment of the invention includes at least one cable for the fixation of the rotor blade or rotor blade segment on a rotor hub or on a further rotor blade segment, and, a connecting surface, which in the mounted state, faces the rotor hub or further rotor blade segment and from which a free end of the at least one cable protrudes for the fixation on the rotor hub or further rotor blade segment. The at least one cable is anchored inside a connecting region of the rotor blade or rotor blade segment which extends only over a longitudinal section of the rotor blade or rotor blade segment which adjoins the connecting surface.

The at least one cable can, in particular, be made of steel but can also be made of plastic. It is constructed from a plurality of elements extending in the longitudinal direction of the cable, in particular, a plurality of strands. In comparison to the massive bolts as connecting means known in the state of the art, the cross-section of the cable can be configured substantially smaller in order to achieve the same tensile strength. A reinforcement of the connecting region is thus not necessarily required. Because of its flexibility, the cable can be guided along the contour of the rotor blade, as a result of which fact cables having a greater length can be used. These have a higher elasticity and can take up tensile stress better than the known bolts.

The connecting surface can be even or curved. It faces the rotor hub or further rotor blade segment and is placed under tension therewith in the mounted state. In particular, the connecting surface can be directly adjoining a connecting surface of the further rotor blade segment or lie against a contact surface, in particular, a flange of the rotor hub. A free end of the cable protrudes from the connecting surface so that by applying a tensile force to the free end, the rotor blade or rotor blade segment can be pulled to the rotor hub or further rotor blade segment.

In the invention, the at least one cable is anchored inside a connecting region, that is to say fixedly connected with the rotor blade or further rotor blade segment. The connecting region thereby extends only over a longitudinal section of the rotor blade or further rotor blade segment which adjoins the connecting surface, and the cable is connected to the rotor blade or rotor blade segment only in this longitudinal section. The longitudinal section extends over only a portion of the total length of the rotor blade or rotor blade section. In another longitudinal section of the rotor blade or rotor blade segment, which adjoins the connecting region, the at least one cable is not anchored. A force transmission from the at least one cable to the rotor blade or the rotor blade segment occurs exclusively in the connecting region.

In contrast to the rotor blade known from U.S. Pat. No. 7,393,184, the invention does not provide that at least one cable is completely guided through the rotor blade or rotor blade segment, which in practice is problematic because of the varying cross-section of the rotor blade over its length. For this reason, the sections of the rotor blade or rotor blade segment, which are different from the connecting region, do not have to take up any tensile stresses applied by the at least one cable and do not require any special reinforcement. The rotor blade or rotor blade segment according to the invention is thus especially simply constructed.

Moreover, because of the anchoring of the cable in the connecting region, additionally an even and secure force transmission to the rotor blade or rotor blade segment is achieved. Where applicable, the connecting region can be reinforced in its entirety or in the region of the at least one cable.

In an embodiment, a fixation segment of the at least one cable is anchored in a substance-to-substance bond and/or force-fit connection and/or form-fit connection. The fixation segment is at least five times as long as the diameter of the at least one cable in the area of the fixation segment. In particular, the fixation segment can be ten times as long as the diameter of the at least one cable in the area of the fixation segment, or longer. As a result of such a fixation of the cable in a relatively long fixation segment, an introduction of force over an especially large area into the rotor blade or rotor blade segment takes place. For example, the anchoring can be substance-to-substance bonded by adhesive bonding or casting of the at least one cable in the rotor blade or rotor blade segment or by pressing-on of a sleeve onto the at least one cable, which, in turn, is connected with the rotor blade or rotor blade segment, for example, by adhesive bonding.

In an embodiment, the anchoring is established in a pre-tensioned state of the at least one cable. This leads to a uniform force transmission to the rotor blade or rotor blade segment over the length of the anchored cable segment.

In an embodiment, an anchoring element on or in which the at least one cable is fixed is arranged within the connection region. For example, the anchoring element can be a sleeve in which the at least one cable is anchored in a force-fit and/or form-fit manner, where appropriate, in a pre-tensioned state. The anchoring element can be connected to the rotor blade or rotor blade segment in a force-fit or form-fit manner. The force is introduced into the rotor blade via the anchoring element.

In an embodiment, the at least one cable is guided through the anchoring element and fixed behind the same. For example, the anchoring element can be a metal plate with a bore through which the at least one cable is passed. The metal plate can be fixedly connected with the rotor blade or rotor blade segment, for example, by adhesive bonding or laminating in the manufacture of the rotor blade or rotor blade segment. The fixation of the at least one cable behind the anchoring element can, for example, be done with the aid of a pressed-on sleeve or a cable clamp.

In an embodiment, one end of the cable, in particular, the end guided through an anchoring element, has a cable end sleeve. The cable end sleeve can be potted with the end of the cable or pressed in with the end of the cable. The cable end sleeve can have a thread on which the cable end sleeve can be fixed, in particular, behind an anchoring element, for example, with a nut.

In an embodiment, the anchoring element is a tube or a hose which is embedded in the wall of the connecting region. The anchoring element can, at the same time, provide a guide for the at least one cable. In this case, the anchoring element can be embedded in the wall of the connecting region already during the manufacture of the rotor blade or rotor blade segment, in particular, by lamination. Subsequently, the at least one cable can be introduced into the anchoring element and be anchored therein or therebehind. Alternatively, it is also possible that the at least one cable is anchored in the anchoring element prior to the embedding of the same, in particular, in a pre-tensioned state, and that subsequently the anchoring element is embedded during the manufacture of the rotor blade or rotor blade segment. This can simplify the manufacture because the anchoring of the cable in the anchoring element can be pre-manufactured independently of further manufacturing steps of the rotor blade or rotor blade segment.

In an embodiment, the at least one cable has a curved course in the connecting region. In particular, the at least one cable runs at a uniform distance from an outer surface of the connecting region, in particular, an aerodynamic surface. In this way, the force transmission from the at least one cable into the rotor blade or rotor blade segment can be optimally adapted to the load carrying capacity of the connecting region.

In an embodiment, an end segment of the at least one cable inside the connecting region protrudes from an inner surface of the connecting region, that is the end segment points toward the interior of the rotor blade. The end segment is located at the end of the cable anchored in the connecting region. It can run at an angle to an outer surface, in particular, an aerodynamic surface of the rotor blade. The end segment can be straight or curved. The inner surface of the connecting region, from which the end segment protrudes, can be an inner side of a wall of the connecting region and be arranged essentially parallel to the outer surface of the connecting region, or at an angle thereto. The inner surface can have a step or form a step from which the end segment protrudes. The protruding end segment is easily accessible from an inner side of the rotor blade or rotor blade segment, both for assembly purposes during the anchoring and for maintenance purposes.

In an embodiment, a longitudinal segment of the at least one cable is not connected to the connecting region between the connecting surface and a segment anchored in the connecting region. The at least one cable thus runs freely in the longitudinal segment and can elastically take up changing tension. It is thus especially quite possible to set a desired pre-tensioning and to maintain it permanently.

In an embodiment, the connecting region has a length of 30 cm or more. The connecting region can also extend over a length of 50 cm, 75 cm or 1 m or more. A relatively long length of the connecting region facilitates a uniform introduction of force into the rotor blade or rotor blade segment via a large area.

The object given above is also solved by the method for fixing a rotor blade or rotor blade segment on a rotor hub or on a further rotor blade segment of a wind turbine.

At least one cable for the fixation of the rotor blade or rotor blade segment on a rotor hub or on the further rotor blade segment is provided. A connecting surface, in the mounted state, faces the rotor hub or further rotor blade segment and from this connecting surface, a free end of the at least one cable protrudes for fixation on the rotor hub or further rotor blade segment. The at least one cable is anchored inside a connecting region of the rotor blade or rotor blade segment and extends only over a longitudinal section of the rotor blade or rotor blade segment which adjoins the connecting surface.

The method according to the invention has the following steps: providing the rotor blade or rotor blade segment and providing a rotor hub or a further rotor blade segment on which the rotor blade or rotor blade segment is to be fixed; arranging the rotor blade or rotor blade segment and rotor hub or further rotor blade segment in a designated mounting position in which the connecting surface faces the rotor hub or further rotor blade segment; and, anchoring the protruding end of the at least one cable in or on the rotor hub or further rotor blade segment.

In view of the method features, reference is made to the above description of the rotor blade or rotor blade segment according to the invention. After anchoring the protruding end of the at least one cable, a heavy-duty connection of the two components is achieved. The method is especially easy to execute because one of the two ends of the at least one cable can already be anchored during the manufacture of the rotor blade or rotor blade segment. At the construction site, only the protruding end of the at least one cable must still be anchored on the rotor hub or further rotor blade segment.

In an embodiment of the method, during the anchoring of the protruding end of the at least one cable in a first step, a defined pre-tensioning is generated and subsequently a fixation of the protruding end takes place. The defined pre-tension can, for example, be generated with a hydraulic clamping tool or any other clamping tool. The fixing of the protruding end can, for example, be done by threadably engaging a nut onto an end sleeve having a thread at the protruding end of the at least one cable. After such a fixation, the clamping tool can be removed and the defined pre-tension will be maintained. In particular, in connection with a segment-like free running cable, the defined pre-tensioning can be maintained exactly and permanently.

In a further embodiment, the protruding end of the cable is anchored on the rotor hub or further rotor blade segment, as described above in relation to the anchoring of the cable segment arranged inside the connection region of the rotor blade or rotor blade segment. For example, a fixation section of the protruding end of the cable can be anchored in a substance-to-substance bond and/or force-fit connection and/or form form-fit connection over a certain length, where appropriate, in the pre-tensioned state of the cable, et cetera. In the case of a connection of two rotor blade segments, the further rotor blade segment can also have a connecting region with one of the above described characteristics. In particular, both ends of the at least one cable can be anchored in the same way in the connection of two rotor blade segments.

### BRIEF DESCRIPTION OF THE DRAWINGS

The invention will now be described with reference to the drawings wherein:

FIG. 1 shows a rotor blade according to the invention having two rotor blade segments in a schematic top view;

FIG. 2 shows a connecting region of the rotor blade segment shown on the right in FIG. 1 in a cross-sectional view;

FIG. 3 shows an enlarged detail view from FIG. 2; and,

FIG. 4 shows another embodiment of a connection region of a rotor blade segment in a cross-sectional view.

### DESCRIPTION OF THE PREFERRED EMBODIMENTS OF THE INVENTION

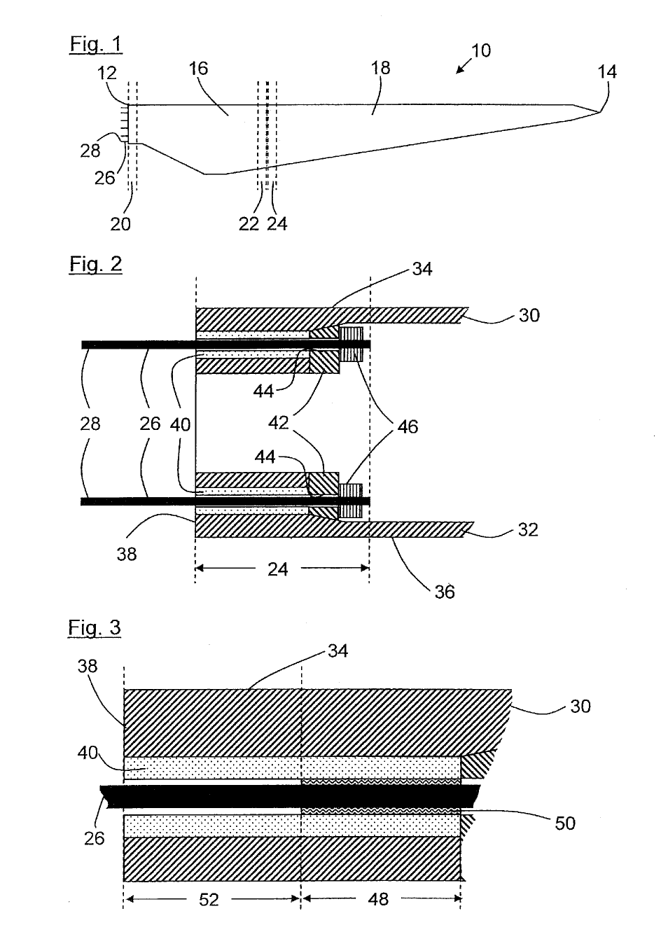

The rotor blade 10 shown in FIG. 1 has a blade root 12 and a blade tip 14. It is composed of two rotor blade segments (16, 18). The blade-root-end rotor blade segment 16 extends from the blade root 12 to about one third of the total length of the rotor blade 10. It has a first connection region 20 which adjoins the blade root 12 and a second connection region 22 which is arranged on the end of the rotor blade segment 16. The end of the rotor blade segment 16 adjoins the rotor blade segment 18 defining the blade tip. The blade-tip-end rotor blade segment 18 extends over about two thirds of the total length of the rotor blade 10. It has a connection region 24 which adjoins the end of the rotor blade segment 18 which faces the blade-root-end rotor blade segment 16. Several steel cables 26, whose free ends 28 protrude from the rotor blade segment 16, are arranged at the blade root 12. The other ends of the cables 26, not shown in FIG. 1, are fixedly anchored in the connecting region of the rotor blade segment 16.

FIG. 2 shows a part of the rotor blade segment 18 of FIG. 1 with the connecting region 24 in a cross-sectional view. The rotor blade segment 18 has two walls (30, 32) comprised of a fiber-reinforced plastic material. The outer side of the wall 30 forms a suction side 34 of the rotor blade and the outer side of the wall 32 forms a pressure side 36 of the rotor blade. The connecting region 24 extends over the longitudinal section of the rotor blade 18 in which the cables 26 are anchored. The longitudinal section is indicated by the corresponding arrow. The cables 26 are steel cables which each have a plurality of strands.

The end of the wall (30, 32) shown in FIG. 2 forms a connecting surface 38 which, in the mounted state, faces the further rotor blade segment 16. It can directly adjoin a connecting surface of the connecting region 22 of the rotor blade segment 16. Where appropriate, an intermediate piece can be interposed.

The walls (30, 32) are thickened inwardly in the connecting region 24. A tube 40 made of steel has one end thereof flush with the connecting surface 38 and is embedded in the thickened region of the walls (30, 32) for each cable 26. The anchoring elements configured as tubes 40 were laminated in during the construction of the walls (30, 32) of fiber reinforced plastic material. At the ends of the tubes 40 remote from the connecting surface 38, a further anchoring element adjoins in the form of a metal plate 42 having a bore 44. The cables 26 are guided through the tubes 40 and the bore 44 in the metal plates 42. Behind the metal plates 42, each cable is secured with a pressed-on retaining element 46.

In the sectional enlargement of FIG. 3, it can be seen that, in addition to this anchoring on the metal plate 42 with the aid of the retaining element 46, a fixation segment 48 of each cable 26 is glued to the tube 40 with adhesive 50. The force introduction in this configuration takes place over a large surface via both anchoring elements into the rotor blade. In FIG. 3, it can also be seen that a further longitudinal segment 52 of the cable 26, which is formed between the connecting surface 38 and the fixation segment 48, is not connected to the rotor blade segment 18. In this longitudinal section 52, the cable 26 runs freely through the tube 40.

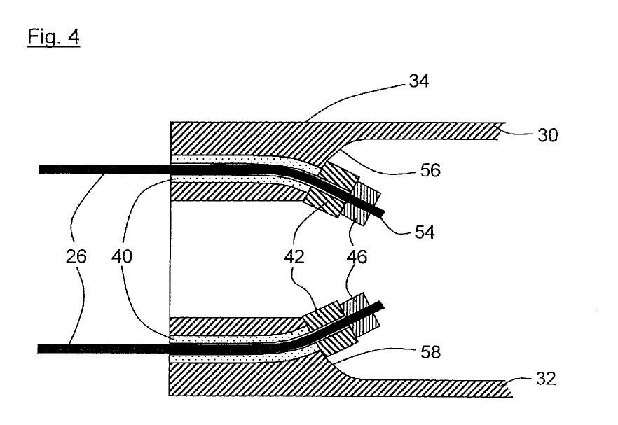

The second embodiment of FIG. 4 shows a view corresponding to FIG. 2 wherein the same reference numerals are used for the corresponding parts as in the first embodiment.

In FIG. 4, an end segment 54 of each cable 26 is arranged at an angle to both the suction side 34 and the pressure side 36 and the cable 26 has a curved course. The end segment protrudes from an inner surface (56, 58) of the wall (30, 32) and points toward the interior of the rotor blade. The tubes 40 are also curved in correspondence to the curved course of the cable 26.

It is understood that the foregoing description is that of the preferred embodiments of the invention and that various changes and modifications may be made thereto without departing from the spirit and scope of the invention as defined in the appended claims.

What is claimed is:

1. A rotor blade unit for a wind turbine having a rotor hub, the rotor blade unit comprising:
a first rotor blade segment extending from the rotor hub;
a second rotor blade segment extending from said first rotor blade segment;
said first and second rotor blade segments having mutually adjacent connecting surfaces conjointly defining an interface;
at least one cable for fixing one of said blade segments to the other one of said blade segments;
said cable having at least one free end protruding from the connecting surface of one of said blade segments;
the other one of said blade segments having a longitudinal section extending from said interface over only a portion of the total length of said other one of said blade segments;
said other one of said blade segments having a connecting region extending over at least a portion of said longitudinal section; and,
said free end of said cable being anchored in said connecting region.

2. A rotor blade unit for a wind turbine having a rotor hub, the rotor blade unit comprising:
a rotor blade;
at least one cable configured to fix said rotor blade on the rotor hub;
said rotor blade having a connecting surface configured to face the rotor hub in the mounted state of said rotor blade;
said cable having at least one free end which protrudes from said connecting surface for attachment to said rotor hub;
said rotor blade having a connecting region extending over at least a portion of a longitudinal section of said rotor blade;
said longitudinal section adjoining said connecting surface and extending over only a portion of the total length of said rotor blade; and,
said cable being anchored in said connecting region.

3. The rotor blade unit of claim 2, wherein:
said cable has a fixation segment and a diameter;
said fixation segment of said cable is anchored with at least one of: a substance-to-substance connection, a friction locked connection, and a form fitting connection; and,
said fixation segment is at least five times as long as said diameter of said cable in the region of said fixation segment.

4. The rotor blade unit of claim 2, wherein said cable is anchored in a pre-tensioned state.

5. The rotor blade unit of claim 2, further comprising:
an anchoring element arranged in said connecting region; and,
said cable being anchored in or on said anchoring element.

6. The rotor blade unit of claim 5, wherein said cable is guided through said anchoring element and is fixed behind said anchoring element.

7. The rotor blade unit of claim 2, wherein:
said cable has two ends; and,
one of said ends of said cable has a cable end sleeve.

8. The rotor blade unit of claim 5, wherein:
said connecting region has a wall; and,
said anchoring element is a tube or hose embedded in said wall of said connecting region.

9. The rotor blade unit of claim 2, wherein said cable has a curved course in said connecting region.

10. The rotor blade unit of claim 2, wherein:
said cable has an end segment;
said connecting region has an inner surface; and,
said end segment of said cable protrudes from said inner surface of said connecting region.

11. The rotor blade unit of claim 2, wherein said cable has an anchored segment anchored in said connecting region and a longitudinal segment which is not connected to said connecting region between said connecting surface and said anchored segment.

12. The rotor blade unit of claim 2, wherein said connecting region has a length of at least 30 cm.

13. A rotor blade unit for a wind turbine comprising:
a first rotor blade segment;
a second rotor blade segment;
at least one cable configured to fix said first rotor blade segment to said second rotor blade segment;
said first rotor blade segment having a connecting surface configured to face said second rotor blade segment in the mounted state of said first rotor blade segment on said second rotor blade segment;
said cable having at least one free end which protrudes from said connecting surface;
said second rotor blade segment having a longitudinal section which adjoins said connecting surface and extends only over a portion of the total length of said second rotor blade segment;
said second rotor blade segment having a connecting region which extends over at least a portion of said longitudinal section; and,
said cable being anchored in said connecting region.

14. The rotor blade segment unit of claim 13, wherein said cable has a fixation section and a diameter; said fixation section of said cable is anchored in at least one of a substance-to-substance bond, a friction locked connection, and a form fitting connection; and, said fixation section is at least five times as long as said diameter of said cable in the area of said fixation section.

15. The rotor blade segment unit of claim 13, wherein said cable is anchored in a pre-tensioned state.

16. The rotor blade segment unit of claim 13, further comprising: an anchoring unit arranged in said connecting region; and, said cable is anchored in or on said anchoring unit.

17. The rotor blade segment unit of claim 16, wherein said cable is guided through said anchoring unit and is fixed behind said anchoring unit.

18. The rotor blade segment unit of claim 13, wherein said cable has two ends; and, one of said ends of said cables has a cable end sleeve.

19. The rotor blade segment unit of claim 16, wherein said connecting region has a wall; said anchoring unit is embedded in said wall of said connecting region; and, said anchoring unit is one of a tube and a hose.

20. The rotor blade segment unit of claim 13, wherein said cable has a curved course in said connecting region.

21. The rotor blade segment unit of claim 13, wherein said cable has an end section; said connecting region has an inner surface; and, said end section of said cable protrudes from said inner surface of said connecting region.

22. The rotor blade segment unit of claim 13, wherein said cable has an anchored section anchored in said connecting region and a longitudinal section which is not connected to said connecting region between said connecting surface and said anchored section.

23. The rotor blade segment unit of claim 13, wherein said connecting region has a length of at least 30 cm.

24. A method for fixing a rotor blade on a rotor hub, said method comprising the steps of:
providing a rotor blade having at least one cable configured to fix said rotor blade on the rotor hub; a connecting surface configured to face the rotor hub in the mounted state of said rotor blade; said cable having at least one free end which protrudes from said connecting surface; a longitudinal section which adjoins said connecting surface and extends only over a portion of the total length of said rotor blade; a connecting region which extends over at least a portion of said longitudinal section; and, said cable being anchored in said connecting region;
providing a rotor hub on which said rotor blade is to be fixed;
arranging said rotor blade and said rotor hub in a designated mounting position in which said connecting surface faces the rotor hub; and,
anchoring said protruding end of said cable in or on said rotor hub.

25. The method of claim 24, wherein said anchoring of said protruding end further comprises:
generating a pre-defined pre-tensioning of said cable; and,
fixing said protruding end of said cable after generating said pre-tensioning of said cable.

26. A method for fixing a first rotor blade segment on a second rotor blade segment, said method comprising the steps of:
providing a first rotor blade segment having at least one cable configured to fix said rotor blade segment on the second rotor blade segment; a connecting surface configured to face the second rotor blade segment in the mounted state of said first rotor blade segment; said cable having at least one free end which protrudes from said connecting surface; a longitudinal section which adjoins said connecting surface and extends only over a portion of the total length of said second rotor blade segment; a connecting region which extends over at least a portion of said longitudinal section; and, said cable being anchored in said connecting region;
providing a second rotor blade segment on which said first rotor blade segment is to be fixed;
arranging said first rotor blade segment and said second rotor blade segment in a designated mounting position in which said connecting surface faces the second rotor blade segment; and,
anchoring said protruding end of said cable in or on said second rotor blade segment.

27. The method of claim 26, wherein said anchoring of said protruding end further comprises:
generating a pre-defined pre-tensioning of said cable; and,
fixing said protruding end of said cable after generating said pre-tensioning of said cable.
